(19) United States
(12) Patent Application Publication
(10) Pub. No.: US 2004/0179224 A1
(43) Pub. Date: Sep. 16, 2004

(54) Image processing apparatus and image processing method

(75) Inventor: Kazuaki Kidokoro, Mishima-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/385,672

(22) Filed: Mar. 12, 2003

(51) Int. Cl. G06F 15/00

(52) U.S. Cl. 358/1.14; 358/1.15; 358/1.13

(57) ABSTRACT

There is provided an image processing apparatus and an image processing method which can simplify operations for input and output of document data to and from a document management system provided with a checkin and checkout function. The image processing apparatus of the present invention is an image processing apparatus A connected to a document repository 16 provided with a checkin and checkout function for documents so as to be able to communicate with each other and inputs and outputs document data to and from the document management system, the image processing apparatus including a DMS connection processing section 12 for, in outputting the document data from the document repository 16, checking out the document data to be outputted and, in inputting a document to overwrite document data on the document repository 16, checking in the document to be inputted to overwrite the document data.

### BACKGROUND OF THE INVENTION

1. Field of the Invention

The present invention relates to an image processing apparatus and an image processing method.

2. Description of the Related Art

An image processing apparatus applicable to network such as a network scanner, a printer, a facsimile apparatus, or an MFP connected to a network has been generally used and a function thereof has been sophisticated. For example, the function includes direct saving of a scanned document in a document management system and direct printing of a document without intervention of a printer driver. Cooperation between an electronic document and a paper document as well as an apparatus and a user environment has been becoming even tighter.

In order to sufficiently cooperate with the user environment, the image processing apparatus is required to be provided with not only an I/F applicable to an existing scanner, printer, or the like but also an I/F for cooperating with a document management system and a user application for workflow or the like.

However, the function provided in the conventional image processing apparatus applicable to a network is confined to simply saving an inputted document in an HDD in the apparatus as a file or saving the document in a file system outside the apparatus in order to simplify processing for cooperating with the user application. In addition, in performing output operation of a document, it is a general form to open a document to be outputted in an application once and, then, print to output it via a printer driver (e.g., see Japanese Patent Application Laid-Open No. 11-85598).

That is, in the case where an electronic document is used in a document repository or a document management system provided with an advanced function or in a workflow system constituted in such an environment, when a user intends to input or output a document image, the user is required to perform work for opening a checked-out document manually in an application once and printing it and work for registering an inputted original, which has been inputted from the apparatus and saved in a file, in the document repository manually. In this way, it is difficult to automate management of a document image, which is in the form of being included in a paper document, in cooperation with the document management system.

However, as the image processing apparatus such as an MFP having an advanced image input and output function has been generally used, there have been increasing demands for document management standardized for the entire system without discrimination between an electronic document and a paper document.

### SUMMARY OF THE INVENTION

The present invention has been devised in order to solve the above-described problems, and it is an object of the present invention to provide an image processing apparatus and an image processing method which can simplify operations for input and output of document data to and from a document management system provided with a checkin and checkout function.

In order to solve the above-mentioned problems, an image processing apparatus in accordance with the present invention is an image processing apparatus which is connected to a document management system provided with a checkin and checkout function for documents so as to be able to communicate with each other and inputs and outputs document data to and from the document management system, the image processing apparatus including a connection processing section for, in outputting the document data from the document management system, checking out the document data to be outputted and, in inputting a document to overwrite document data in the document management system, checking in the document to be inputted to overwrite the document data.

With such a structure, even in the case where the document management system provided with an advanced function such as the checkin and checkout function is used for management of document data, it becomes unnecessary for a user to open a checked-out document manually in an application once to print the document or register document data acquired on the image processing apparatus side, which the user intends to input to overwrite the document, manually in the document management system as in the past.

As a result, the operations for input and output of document data to and from the document management system provided with the checkin and checkout function can be performed by operations in the image processing apparatus and can be simplified. That is, the image processing apparatus is provided with a cooperation function with the document management system and is capable of performing the document input and output operations simply in a UI of the apparatus, whereby simple cooperation between the document management system and the image processing apparatus can be realized.

In addition, in the image processing apparatus with the structure as described above, it is preferable that, in outputting document data, the connection processing section sets document data to be outputted to be inaccessible in the document management system. In this way, users other than a user who outputs the document data are prohibited from accessing the document data, whereby, for example, a situation in which a plurality of users input documents to overwrite the document data simultaneously can be prevented.

Note that the connection processing section is desirably constituted not to output the document data which is set to be inaccessible. When document data is in an inaccessible state, that is, when the document data is being outputted, it is highly likely that contents of the document are, for example, updated. Consequently, such that a user can always output document data with the latest contents, other users are made inaccessible to the document when the user is outputting the document.

In addition, the connection processing section is constituted so as to, in outputting document data from the document management system, set the document data to be outputted as already referenced.

Note that the connection processing section can be adapted to save referrer information concerning document data outputted in the document management system.

In addition, the image processing apparatus as described above can also be constituted so as to output at least one of version information, an owner, and an update history concerning document data to be outputted individually or together with the document data to be outputted.

It is preferable that the image processing apparatus as described above is provided with an image forming section for forming an image on a sheet and is constituted to output document data with the image forming section. However, the image processing apparatus is not limited to this. The image processing apparatus may be provided with a mail transmission section and output document data by performing mail transmission or may be provided with a facsimile transmission section and output document data by performing facsimile transmission. Naturally, the image processing apparatus may set an output destination of document data to a storage area provided in the image processing apparatus itself or a storage area provided in an external device, and save a file therein.

Further, the image processing apparatus as described above can also be constituted so as to, based upon an update history of document data to be outputted in the document management system, output the document data such that at least an updated part is highlighted. According to such a constitution, a changed part of the document data can be easily grasped visually, which contributes to improvement of work efficiency.

Here, “outputting document data such that an updated part is highlighted” means, for example, outputting the document data with the updated part distinguished by using a different color, outputting only the updated part, or outputting the document data while comparing the updated part and a part of an original document.

In addition, as described above, after overwriting input has been completed for document data which is set to be inaccessible when it is outputted from the document management system, the document data for which overwriting input has been completed is set to be accessible, whereby the document data to which exclusive lock is applied can be made accessible to the other users.

In addition, in the image processing apparatus as described above, it is preferable that document data to be inputted to overwrite document data on the document management system is acquired by an image reading section for reading an image, acquired by receiving as facsimile data in a facsimile receiving section for receiving facsimile transmission, or acquired by receiving as an Email in an Email receiving section for receiving an Email.

Other than the above, the image processing apparatus may be provided with an image forming section for forming an image on a sheet and constituted such that document data, which is inputted to overwrite document data on the document management system, is inputted to overwrite the document data by this image forming section.

Further, in the image processing apparatus as described above, it is desirable that the connection processing section adds information for specifying a user, who has inputted document data to overwrite document data, to the document data to be inputted to overwrite the document data.

Note that, in the image processing apparatus as described above, at least one of a version number, an owner, and an update history concerning the document data to be outputted may be outputted individually or together with the document data to be outputted.

In order to solve the above-described problems, an image processing method in accordance with the present invention is an image processing method in an image processing apparatus for outputting document data from a document management system having a checkin and checkout function for documents to the image processing apparatus, the image processing method including: a step of selecting document data in the document management system; a step of checking out the selected document data; and a step of outputting the checked-out document data.

In addition, another image processing method in accordance with the present invention is an image processing method in an image processing apparatus for performing overwriting input of document data to a document management system having a checkin and checkout function for documents from the image processing apparatus, the image processing method including: a step of selecting document data in the document management system; a step of checking in the selected document data; and a step of performing overwriting input to the checked-in document data.

### DESCRIPTION OF THE DRAWINGS

In the accompanying drawings:

FIG. 1 is a functional block diagram of an image processing apparatus according to an embodiment of the present invention;

FIG. 2 is a flowchart showing a flow of document output processing in the image processing apparatus according to the embodiment of the present invention;

FIG. 3 is a flowchart showing a flow of document output processing from a printer driver;

FIG. 4 is a flowchart showing a flow of processing for inputting a scanned document to a document repository;

FIG. 5 is a flowchart for explaining a flow of processing for re-input to the document repository by Email reception or facsimile reception;

FIG. 6 is a table for recording re-input setting information designated by a user on a re-input setting screen;

FIG. 7 illustrates an example of screen display in a display section;

FIG. 8 illustrates an example of a re-input setting screen in the display section;

FIG. 9 illustrates an example of an output content setting screen in the display section; and

FIG. 10 illustrates a display screen at the time when an operation by the printer driver 15 is performed;

FIG. 11 illustrates an example of screen display on a touch panel of the image processing apparatus; and

FIG. 12 illustrates a re-input screen according to a re-input button for scan input.

### DESCRIPTION OF THE PREFERRED EMBODIMENTS

An image processing apparatus and an image processing method according to an embodiment of the present invention will be hereinafter described with reference to the accompanying drawings.

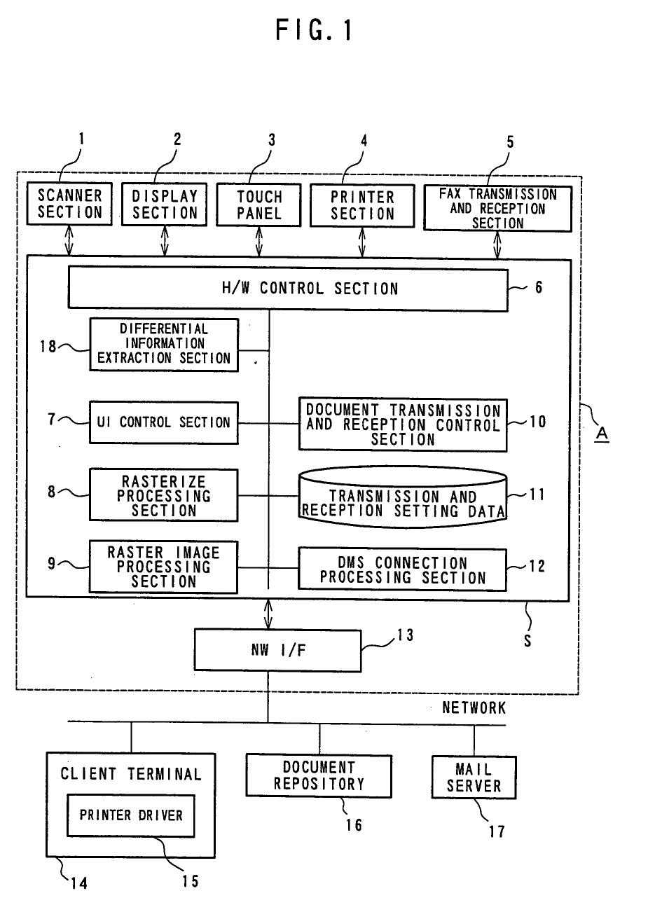

FIG. 1 is a functional block diagram of an image processing apparatus A according to the embodiment of the present invention. As shown in the figure, the image processing apparatus A according to this embodiment is provided with: a system unit S having an H/W control section 6, a UI control section 7, a rasterize processing section 8, a raster image processing section 9, a document transmission and reception control section 10, transmission and reception setting data 11 stored in a not-shown storage area, a DMS connection processing section 12, and a differential information extraction section 18; a scanner section 1, a display section 2, a touch panel 3, a printer section 4, and a facsimile transmission and reception section 5 which serve as input and output devices for documents connected to the system unit S via the H/W control section 6; and an NWI/F (network interface) 13 for allowing the image processing apparatus A to perform network connection and communication with external equipment.

In addition, the image processing apparatus A is connected to a client terminal 14 in which a printer driver 15 is installed, a document repository 16, and a mail server 17 via the NWI/F 13 through a network.

The scanner section 1, the display section 2, the touch panel 3, the printer section 4, and the facsimile transmission and reception section 5 are controlled by the system unit S.

A user performs operational input or the like to the image processing apparatus A by the use of the display section 2 (LCD panel) and the touch panel 3, or over the network via the NWI/F 13.

Note that, although the image processing apparatus provided with the scanner section 1, the printer section 4, the facsimile transmission and reception section 5, and the like is shown in this embodiment, the present invention is not limited to this but is also applicable to an image processing apparatus with a single function such as a network scanner, a network printer, or a facsimile apparatus. In addition, the present invention is applicable to an image processing apparatus regardless of whether an image to be handled by the image processing apparatus is a color image or a monochrome image.

The UI control section 7 receives operational input of a user via the display section 2 and the touch panel 3. As described above, the image processing apparatus A is connected to the client terminal 14 via a network and can receive a document written in the PDL (page description language) generated by the printer driver 15 installed in the client terminal in the same manner as a usual network printer or facsimile apparatus. In addition, the image processing apparatus A is also connected to the document repository 16 or a not-shown DMS (document management system) arranged on the network via the DMS connection processing section 12 and can directly rasterize a document of an application format saved in the repository. In general, a format such as PDF or XML is often used as an application format to be directly rasterized.

The document repository 16 or the DMS is a repository for saving a document file (document data). In addition to controlling access by a unit of user, the repository has functions such as version control of a document, saving of an access history, and access control according to a state of a document such as checkin or checkout.

Usually, dedicated client software is used in order to access such a repository. In this system, the DMS connection processing section has a client function for accessing this repository.

The raster image processing section 9 is a general-purpose image processing module and can apply processing such as compression or development, enlargement or reduction, rotation, or image edition to raster data generated by the rasterize processing section 8.

The document transmission and reception control section 10 performs control of various network protocols and performs processing for receiving a document using a print protocol such as lpr, receiving an Email or an iFAX attached with a document from an external mail server 17 using the SMTP/POP protocol, or, conversely, sending a document image taken in by the scanner section 1 to a network as an attached file of the Email. The transmission and reception setting data 11 stored in a not-shown storage area (HDD, FROM, etc.) is data of a facsimile destination or an Email destination stored in the form of a transmission destination list. In document transmission from the image processing apparatus A, the user designates a transmission destination of a document by inputting the transmission destination using the display section 2 and the touch panel 3 as described later or selecting buttons to which transmission destinations prepared in advance based upon the transmission and reception setting data 11 are allocated.

Next, a flow of processing in the image processing apparatus A will be described.

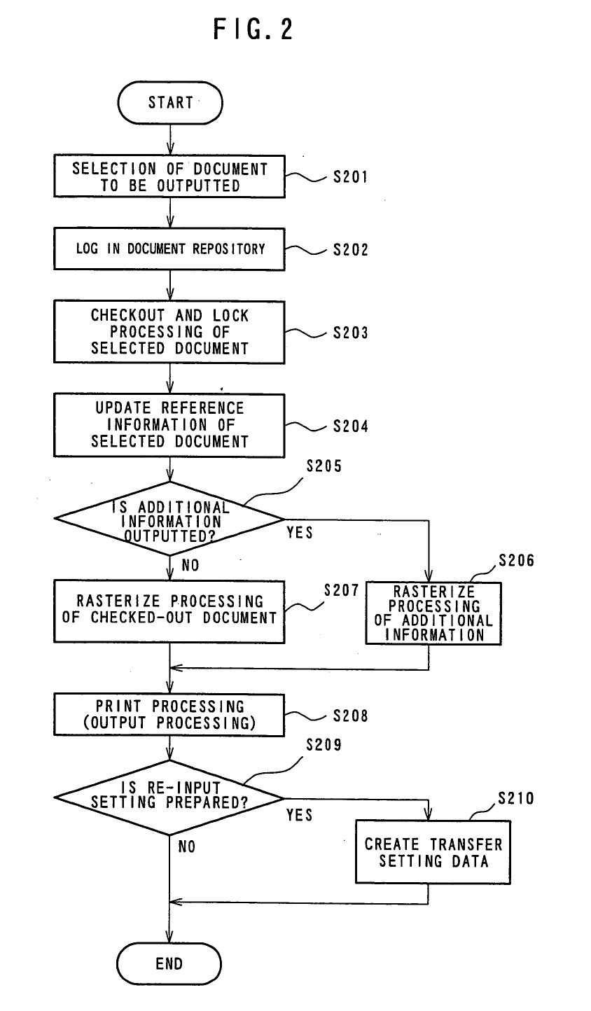

FIG. 2 is a flowchart showing a flow of processing for designating a document stored in the document repository 16 from the touch panel 3 to output and transfer the document. In addition, FIG. 7 shows an example of screen display in the display section 2 at the time when this processing is performed.

The user selects a document to be outputted that is stored on the document repository 16 using the display section 2 and the touch panel 3 (S201). FIG. 7 shows a name of a server of the document repository 16 to which the image processing apparatus A is connected and an example of display 701 of a document tree in this server. The image processing apparatus A is connected to the document repository 16 by the input of a user name 702 and a password 703 shown in FIG. 7. A state of a document is also managed in the document repository 16. For example, in FIG. 7, a “concept chart” document is marked with X. This means that the “concept chart” document is set to a state in which it is inaccessible (unable to be read or written) by the other users or a read-only state.

That is, when the user checks out the designated document, the document is handled as a document in the read-only state in which it cannot be at least updated. Thus, both the documents in the inaccessible state and the read-only state are displayed as documents in a state in which they cannot be outputted.

When the document is selected, the image processing apparatus A logs in the document repository 16 using an account designated by the user name 702 and the password 703 inputted from the touch panel 3 (S202), performs checkout processing of the selected document (download processing to the image processing apparatus A), and performs lock processing of the selected document (S203). At this point, the image processing apparatus A saves a record of reference to the document selected by the user of the designated account in the document repository 16 (S204). According to the lock processing, the selected document is brought into a state in which exclusive lock is applied to it according to an authority of the designated user, and the users other than the designated user become unable to update this document.

Subsequently, the user presses an output content button 706 displayed on the display section 2, whereby an output content setting screen as shown in FIG. 9 is displayed. The user can designate a form of a document to be outputted from the image processing apparatus A on this screen (S205). More specifically, when the user checks a checkbox 901, a version number of the document managed in the document repository 16 is added to an output image as an image in a header or footer area thereof. In checkboxes 902 and 903, creator information and date and time of update of the document are added, respectively. If a checkbox 904 is checked, the image processing apparatus A downloads the document of the latest version and the document of the previous version from the document repository 16, compares both the versions to find a difference between them, and discriminates and highlights the difference between both the versions by using different colors to form an output image. If a checkbox 905 is checked, only this differential part is used for output information. Additional information designated in this way is subjected to rasterize processing in the rasterize processing section 8 (S206).

On the other hand, in the case where additional information is not outputted for the selected document, the checked-out document is directly subjected to rasterize processing (S207).

As described above, the image processing apparatus A according to this embodiment is a multifunction processing machine (MFP) having a plurality of functions. As an output method for a checked-out document, it is possible to select facsimile transmission, Email transmission, or the like other than print processing. The user can select an output and transmission method to be used among these plurality of output methods by selecting a button to be depressed among a print button 707, a facsimile transmission button 708, and a mail transmission button 709 (see FIG. 7) displayed on the display section 2 (S208).

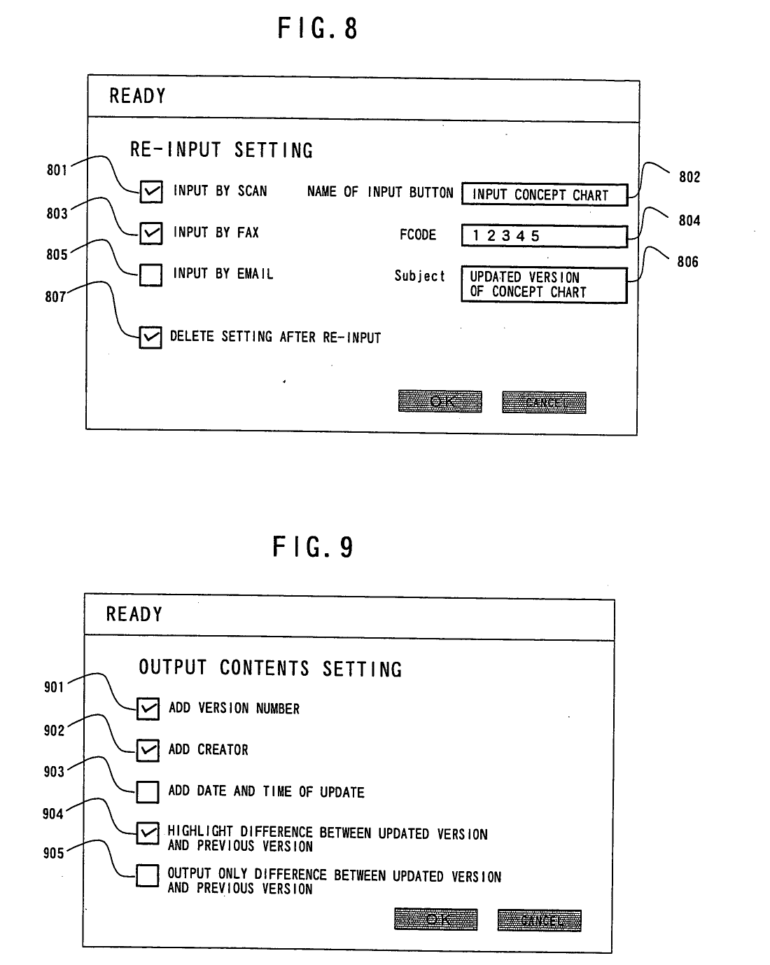

A re-input setting button 705 shown in FIG. 7 is prepared for performing setting for re-selecting and re-inputting (updating) a document on the document repository 16 which has been outputted in the processing of the flowchart shown in FIG. 2 and come into a checkout state. When the re-input setting button 705 is depressed, a re-input setting screen shown in FIG. 8 is displayed. On the re-input setting screen, the user can select a method of inputting contents of a new document for updating the checked-out document out of methods of reading by a scanner, reception by a facsimile apparatus, and reception by an Email. More specifically, the user selects a method of re-input by checking a checkbox 801 (reading by a scanner), a checkbox 802 (reception by a facsimile apparatus), and a checkbox 803 (reception by an Email) on a display screen shown in FIG. 8.

In order to judge which output document the document, which is inputted by the re-input method selected as described above, corresponds to, a button dedicated for re-input having a name (input button name 802) designated by the user in advance is prepared in the case where the document is re-inputted according to reading by a scanner or an FCODE 804 for a received facsimile is designated in advance in the case where the document is re-inputted by facsimile reception, whereby a correspondence relation of the documents is stored. In addition, in the case where the document is re-inputted by Email reception, when an Email having a Subject 806 designated in advance at the time of re-input setting is received, re-input (update) processing of a document using the re-input setting defined here is automatically performed.

When the re-input processing is performed, since an exclusive state of the document, which has been brought into the exclusive state by the output processing, is released, it is not so necessary to use the same re-input setting many times. Thus, if the user checks the checkbox 807 at the time when the document is outputted, re-input setting used in later re-input processing is deleted automatically after the use, and the re-input processing can be prevented from being applied to the same document many times.

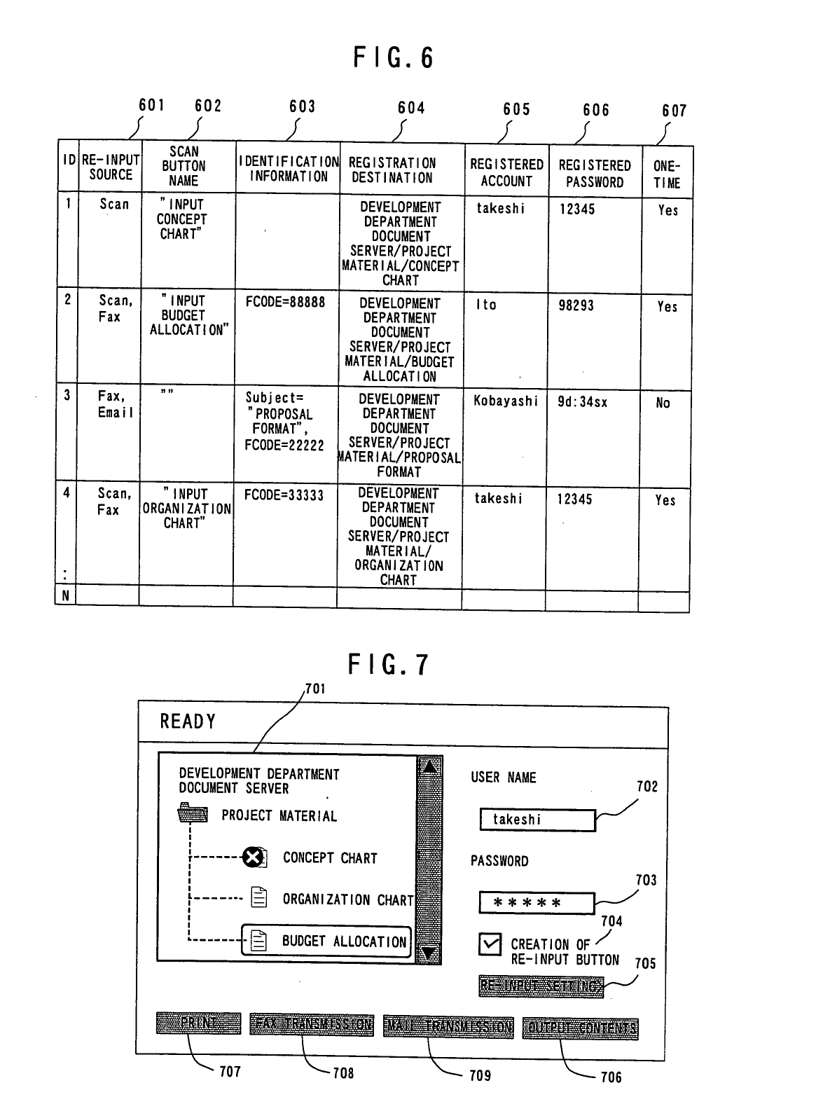

FIG. 6 is a table for recording re-input setting information designated by the user on the re-input setting screen shown in FIG. 8. More specifically, in the table, there are recorded an input source 601 to be used for re-input, a button name 602 for, in the case where a scan button is used, judging processing contents allocated to the button, identification information 603 for judging whether or not a document inputted in the apparatus by facsimile reception or Email reception is a re-input document, a registered account 605 and a registered password 606 which are account information of the user, presence or absence 607 of one-time setting (described later), and the like.

For example, in the case where an FCODE “88888” is allocated to a facsimile job received by the facsimile transmission and reception section 5, existence of an entry matching this received FCODE is retrieved. As a result of retrieval, if the matching entry (in this example, setting of ID2 shown in FIG. 6) exists, the image processing apparatus uses the user account (the registered account 605 and the registered password 606) designated in the contents of re-input setting to perform processing for checking in a document on the document repository 16 which is designated as a corresponding registration destination 604.

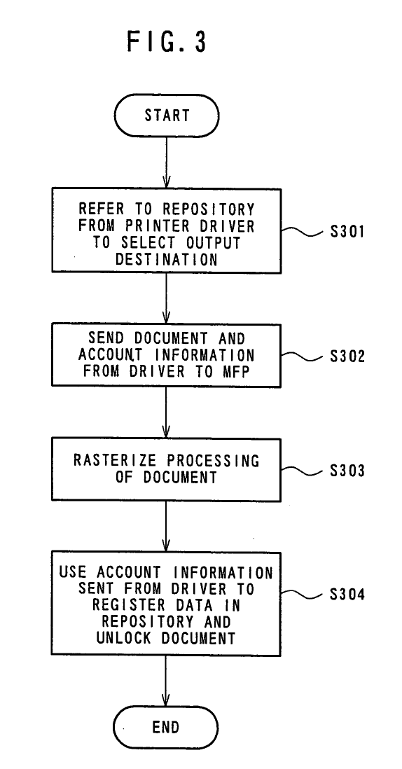

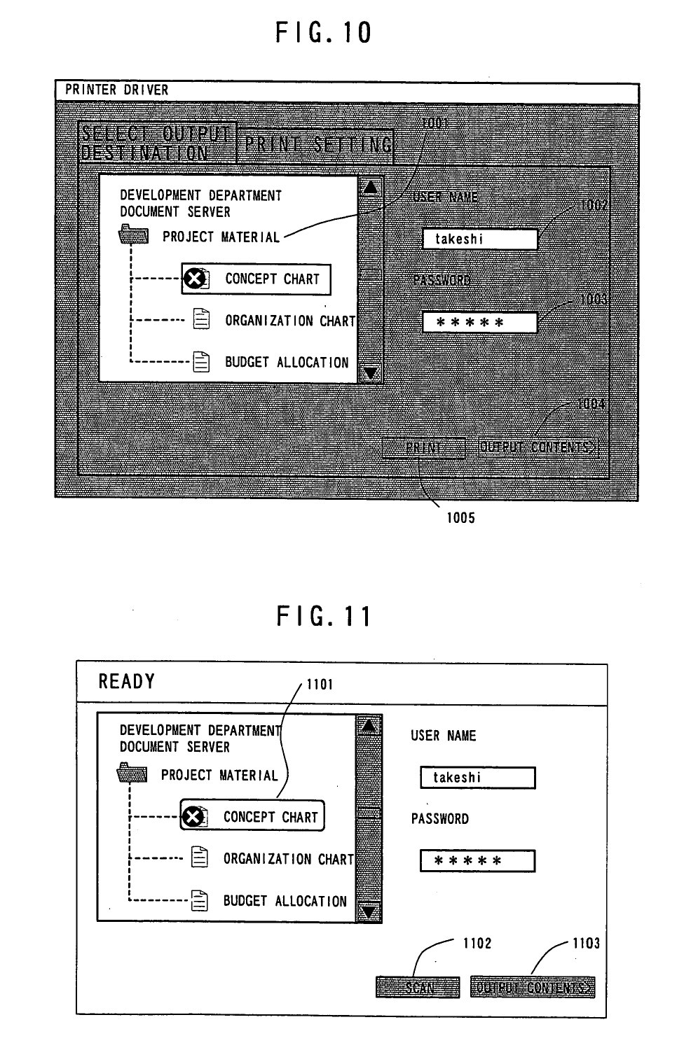

FIG. 3 is a flowchart showing a flow of document output processing from the printer driver 15 installed in the client terminal 14. The printer driver 15 can designate a document on the document repository 16 instead of a printer as an output destination of a document to be printed. FIG. 10 shows an example of screen display at the time when an operation is performed by the printer driver 15 on a not-shown operation screen of the client terminal 14. The printer driver 15 is started up with an application on the client terminal 14, accesses the document repository 16 to perform tree display 1001 and set an access count for accessing the document repository 16 in the same manner as the setting performed on the display section of the apparatus shown in FIG. 7 and the touch panel. Since a document on the document repository 16 is overwritten by a document to be outputted from the application via the printer driver 15, a document which has already come into a checkout state can also be selected as a document to be selected in this tree. When an output content display button 1004 is depressed, the same screen as the output content setting screen shown in FIG. 9 is displayed on the printer driver 15. In the case where addition of differential information is designated on the output content setting screen (checkbox 905 in FIG. 9), the differential information extraction section 18 in the system unit S compares a latest document in the document repository 16 and a new document for overwriting sent from the printer driver 15 on the client terminal 14 and extracts differential information.

The printer driver 15 converts the new document for overwriting opened in the application on the client terminal 14 into PDL (page description language) to send it to the image processing apparatus A and, at the same time, sends a document to be overwritten and updated, which the user selected referring to the document repository 16 (S301), account information, and set contents to the image processing apparatus A (S302). The image processing apparatus A, which has received the information sent from the printer driver 15, performs rasterize processing of the new document for overwriting received from the printer driver 15 in the rasterize processing section 8 (S303). Then, the image processing apparatus A performs update processing (data registration) of the selected document in the document repository 16 to unlock the selected document (S304).

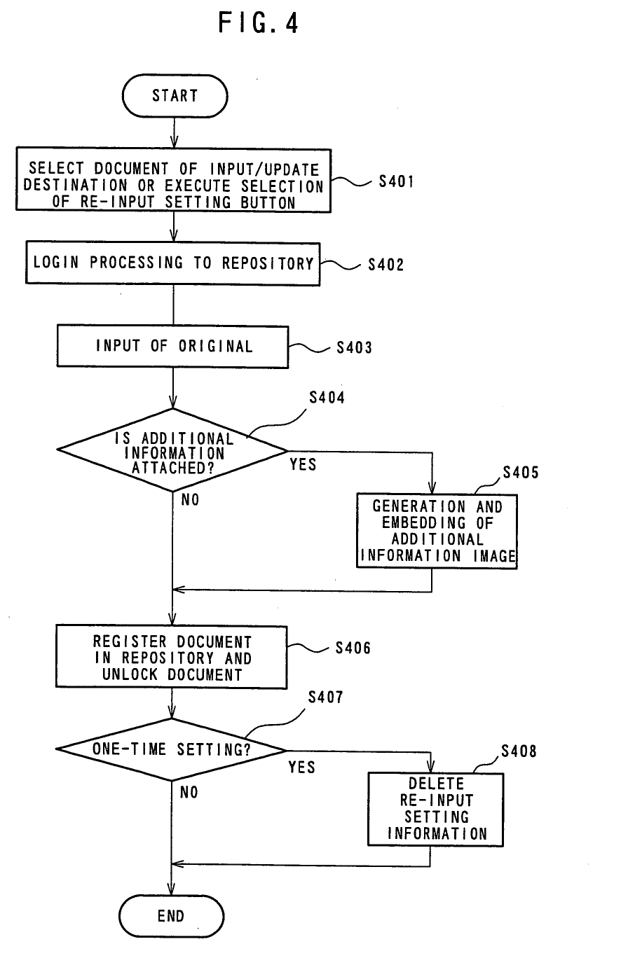

FIG. 4 is a flowchart showing a flow of processing for registering a document read by the scanner section 1 in the document repository 16 as new document data for overwriting. Input by the scanner section 1 is used, for example, at the time when a document outputted by printing, an Email, or a facsimile apparatus is inputted to the document repository 16 again. Thus, the processing is started by selecting a document on the document repository 16 to be re-registered at the time of scan input (S401). FIG. 11 shows an input screen to be displayed on the touch panel 3 in the image processing apparatus A. On the input screen, the user can browse a document tree 1101 on the document repository 16 to select a document of a registration destination. In this figure, the selected document is a document named “concept chart” which has already been outputted and come into a checkout state (a state in which it is locked). When a button 1103 is depressed, the same output content setting screen as in FIG. 9 is displayed, and the user can select additional information for the document to be inputted.

Scan processing by the scanner section 1 is started with the contents selected by depressing a button 1102.

A document, which was outputted once in the past, is required to be re-registered in the document repository 16 in time because it comes into a checkout state on the document repository 16. Information for such re-registration is often known at the time of output.

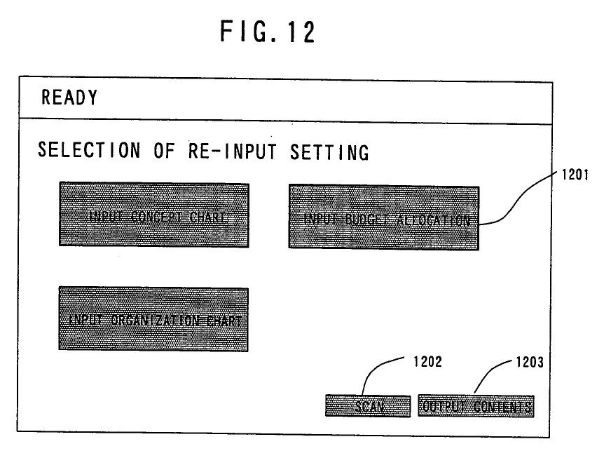

As described above, setting for re-input can be saved in advance at the time of output of a document. FIG. 12 is a screen on which the saved setting for re-input (see FIG. 6) is displayed for scan input as an example of this. Information for which scan is set as the re-input source 601 is displayed on the touch panel 3 as scan buttons 1201. A name of the scan button in this case is registered in advance as a name of scan button 602 as shown in the table of FIG. 6. The user can perform re-input processing of a document without inputting redundant information by selecting one of displayed buttons and depressing a SCAN button 1202. A button 1203 is a button for displaying the same output content setting screen as FIG. 9 and can select additional information of a document at the time of re-input processing.

When the user depresses the SCAN button (1102 or 1202), the image processing apparatus A logs in the document repository 16 using given user information (S402). Subsequently, the image processing apparatus A inputs a document image according to a scan operation in the scanner section 1 (S403), judges whether or not processing of the inputted document image (attachment of additional information, etc.) is performed using the information on the document repository 16 according to setting of the user (S404), and, if the attachment of additional information is performed, generates and embeds an additional information image (S405). On the other hand, if the attachment of additional information or the like is not performed, the image processing apparatus A directly proceeds to the next step.

Subsequently, the image processing apparatus A checks in the inputted new document in the document repository 16 as a new version of a document designated in advance (registration in the document repository 16) (S406). At this point, lock of the designated document is released (unlock).

Next, the image processing apparatus A judges whether or not one-time setting is made for the used re-input button (S407). As a result of the judgment, if the one-time setting described in FIG. 6 is made for the re-input button, when the re-input processing of a document is completed, the image processing apparatus A performs processing for deleting the used re-input setting entry (S408). This processing is for preventing one document from being redundantly re-inputted without undergoing checkout processing according to a request from the image processing apparatus A, and is effective for keeping consistency of update history of a document.

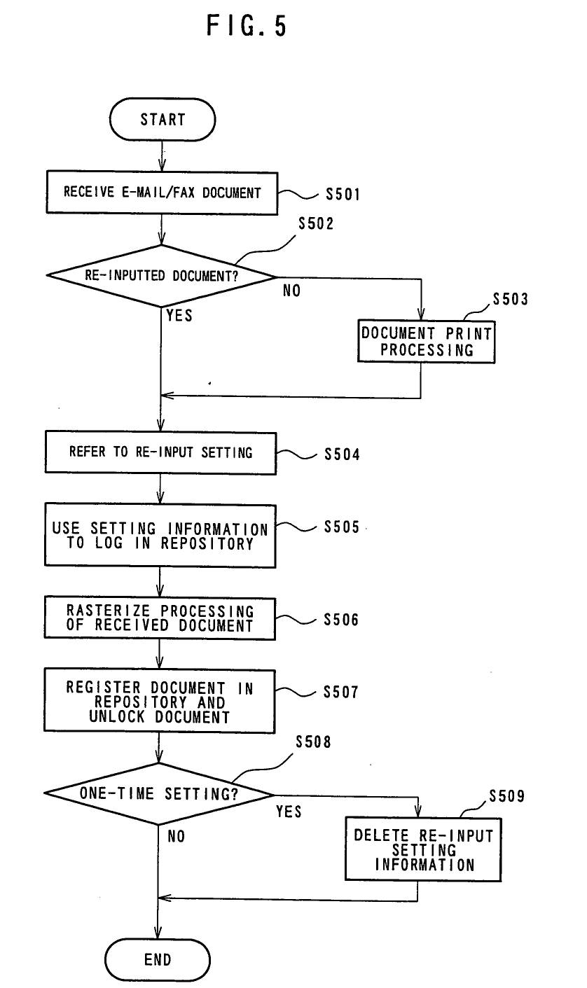

FIG. 5 is a flowchart for explaining a flow of processing for re-inputting a document on the document repository 16 by Email reception or facsimile reception rather than scan input by the scanner section. Reception of a document by Email includes reception by iFAX, and the document is received as an attachment file of the Email. Functions such as a POP client, an IMAP client, and an SMTP client are implemented in the apparatus in advance, and the Email is received via a protocol of any one of the clients (S501).

In the case where re-input (update) processing of a document is performed by Email reception or facsimile reception, since it is difficult for the user to directly refer to the document repository 16, the image processing apparatus A refers to the re-input setting (FIG. 6) set in advance, whereby the re-input processing is performed. Upon receiving an Email or facsimile, the image processing apparatus A refers to the saved re-input setting information (FIG. 6) and refers to conditions saved in the identification information 603 to judge whether or not the received Email or facsimile is an object of re-input (S502). If a document which does not meet the conditions is received, the image processing apparatus A performs print processing of the document (S503).

On the other hand, if a document to be inputted is a re-input document, the image processing apparatus A refers to setting information (the registered account 605, the registered password 606, etc.) concerning re-input setting for the registration destination 604 in FIG. 6 (S504) and logs in the document repository 16 using this setting information (S505).

Subsequently, the image processing apparatus A performs rasterize processing of the received document with the rasterize processing section 8 (S506) and registers the document subjected to the rasterize processing in the document repository 16. At the same time, the image processing apparatus A unlocks the registered and updated document (S507).

Next, the image processing apparatus A judges whether or not one-time setting is made for the re-input button (S508) and, if one-time setting is made, deletes the re-input setting after input of the document to the document repository 16 (overwrite processing) is completed (S509).

As described above, it is desirable that the image processing apparatus in accordance with the present invention is constituted to have means for accessing a document repository, directly access a document managed in the document repository, check out to output the document from the document repository at the time of output, and check in an input destination document of the document repository at the time of input.

In addition, the image processing apparatus may access the document repository when the document is outputted from the image processing apparatus and set an output document to be inaccessible. In this case, it is advisable to adapt the image processing apparatus not to output the document set to be inaccessible.

Moreover, the image processing apparatus can also access the document repository when the document is outputted from the image processing apparatus and set an output document as already referenced. In addition, the image processing apparatus can also leave referrer information in the output document.

Note that the image processing apparatus can also be constituted to output both additional information and a document main body, which are managed in the document repository, together or output the additional information independently from the image processing apparatus.

Further, as described above, printing, mail transmission, facsimile transmission, or file saving can be set as an output destination of document data from the document repository.

In the image processing apparatus as described above, it is also possible to use a version number, an owner, or an update history as the additional information managed in the document repository.

Moreover, when an update history of a document is used as information managed in the document repository, it is possible to use a document instructed to be outputted and an update history of the document to distinguish an updated part by using a different color to output the updated part, output only the updated part, or comparatively print the updated part and a part of an original document.

It is also preferable to designate a document on the document repository from the image processing apparatus, apply overwriting input to this designated document, and reset the document to be accessible when this document is saved.

In addition, it is desirable to add information for specifying inputting person information to document data to be inputted to the document repository from the image processing apparatus.

That is, according to the present invention, it becomes possible to easily access the document repository for managing a document of a user in a consistent state by using a UI of the image processing apparatus, and it also becomes possible to manage not only a conventional electronic document but also both a paper document and an image document together.

As described above in detail, according to the present invention, an image processing apparatus and an image processing method can be provided which can simplify operations for inputting and outputting document data to and from a document management system provided with a checkin and checkout function.

What is claimed is:

1. An image processing apparatus which is connected to a document management system provided with a checkin and checkout function for documents so as to be able to communicate with each other and inputs and outputs document data to and from the document management system, the image processing apparatus comprising a connection processing section for, in outputting the document data from said document management system, checking out the document data to be outputted and, in inputting a document to overwrite document data in said document management system, checking in the document to be inputted to overwrite the document data.

2. The image processing apparatus according to claim 1,
wherein, in outputting document data, said connection processing section sets the document data to be outputted to be inaccessible in said document management system.

3. The image processing apparatus according to claim 2,
wherein said connection processing section does not output the document data when it is set to be inaccessible.

4. The image processing apparatus according to claim 1,
wherein, in outputting document data from said document management system, said connection processing section sets the document data to be outputted as already referenced.

5. The image processing apparatus according to claim 1,
wherein said connection processing section saves referrer information concerning document data outputted in said document management system.

6. The image processing apparatus according to claim 1,
wherein at least one of version information, an owner, and an update history concerning the document data to be outputted is outputted individually or together with the document data to be outputted.

7. The image processing apparatus according to claim 1, further comprising an image forming section for forming an image on a sheet,
wherein the document data to be outputted is outputted by said image forming section.

8. The image processing apparatus according to claim 1,
wherein, based upon an update history of the document data to be outputted in said document management system, the document data is outputted such that at least an updated part is emphasized.

9. The image processing apparatus according to claim 2,
wherein, after overwriting input has been completed for document data on said document management system, the document data for which overwriting input has been completed is set to be accessible.

10. The image processing apparatus according to claim 1, further comprising an image reading section for reading an image,
wherein document data to be inputted to overwrite document data on said document management system is acquired by said image reading section.

11. The image processing apparatus according to claim 1, further comprising an image forming section for forming an image on a sheet,
wherein document data to be inputted to overwrite document data on said document management system is inputted to overwrite the document data by said image forming section.

12. The image processing apparatus according to claim 1, further comprising a facsimile receiving section for receiving facsimile transmission,
wherein document data to be inputted to overwrite document data on said document management system is received in said facsimile receiving section as facsimile data.

13. The image processing apparatus according to claim 1, further comprising an Email receiving section for receiving an Email,
wherein document data to be inputted to overwrite document data on said document management system is received in said Email receiving section as an Email.

14. The image processing apparatus according to claim 1,
wherein said connection processing section adds information for specifying a user, who has inputted document data to overwrite the document data, to the document data to be inputted to overwrite the document data.

15. The image processing apparatus according to claim 1,
wherein at least one of a version number, an owner, and an update history concerning the document data to be outputted is outputted individually or together with the document data to be outputted.

16. An image processing method in an image processing apparatus for outputting document data from a document management system having a checkin and checkout function for documents to said image processing apparatus, the image processing method comprising:
a step of selecting document data in said document management system;
a step of checking out the selected document data; and
a step of outputting the checked-out document data.

17. An image processing method in an image processing apparatus for performing overwriting input of document data to a document management system having a checkin and checkout function for documents from said image processing apparatus, the image processing method comprising:
a step of selecting document data in said document management system;
a step of checking in the selected document data; and
a step of performing overwriting input to the checked-in document data.
